(19) United States
(12) Patent Application Publication
(10) Pub. No.: US 2013/0080959 A1
(43) Pub. Date: Mar. 28, 2013

(54) SIMPLIFIED NAVIGATION AMONG PROCESS CONTROL VIEWS IN A PROCESS CONTROL SYSTEM

(71) Applicant: ABB Technology AG, Zurich (CH)

(72) Inventor: Claus VETTER, Buchs (CH)

(73) Assignee: ABB Technology AG, Zurich (CH)

(21) Appl. No.: 13/680,704

(22) Filed: Nov. 19, 2012

Related U.S. Application Data
(63) Continuation of application No. PCT/EP2011/058128, filed on May 19, 2011.

(30) Foreign Application Priority Data
May 19, 2010 (EP) 10163304.8

(51) Int. Cl. G06F 3/0481

(52) U.S. Cl. CPC G06F 3/0481
USPC 715/771

(57) ABSTRACT

A method is provided for simplifying navigation for a user among process control views on a user terminal display of a process control system. The method includes presenting a current main process control view in a first main view window together with a number of additional views in a second additional views window, receiving, from the user, a selection of a view in the second window to be main process control view, setting the selected view as current main process control view, choosing a group of views to be presented as additional views in the second window based on an additional view selection criterion, and repeating presenting current main process control view according to the received selection with the chosen group of views as additional views in the second window. Also provided are a user terminal and a non-transitory computer-readable recording medium having a computer program for simplifying such navigation.

### RELATED APPLICATIONS

This application claims priority as a continuation application under 35 U.S.C. §120 to PCT/EP2011/058128, which was filed as an International Application on May 19, 2011 designating the U.S., and which claims priority to European Application 10163304.8 filed in Europe on May 19, 2010. The entire contents of these applications are hereby incorporated by reference in their entireties.

### FIELD

The present disclosure generally relates to user terminals in process control systems. More particularly, the present disclosure relates to a method for simplifying for a first user to navigate among process control views on a user terminal display of a process control system. Such simplified navigation is also provided by means of a user terminal and a non-transitory computer-readable recording medium having a computer program for causing a processor of a computer processing device to carry out the method.

### BACKGROUND INFORMATION

Operators view information relating to a technical process being controlled in a process control system. The technical process may be a process such as the process of electrical power transmission. Information can be sent from process interface units to the process control system, where the process control system visualizes the process control information in different process control views that can be seen in different windows.

When an operator is presented with information in one such view, the operator or user may need to find additional information in one or more other views. The operator or user may then need to search for such further information in several “pages” or views of the process control system. These views may be organized in some kind of menu system. An operator or user will then have to navigate through the menu system in order to obtain the different views and then perform some kind of activity like a control action.

This navigation in the menu system can be tedious, time consuming and even at times complicated. Furthermore, with such view navigation, the act of navigating will take away the focus of the user from what is essential, namely viewing the process and acting on events in the process, and instead concentrate on the activity of locating the information that is needed for being involved in the control of the process. This may in the worst case cause the user to make bad decisions.

By way of example, the Detector Control System (DCS) of the ATLAS experiment is reported to include a Finite State Machine (FSM) operator interface. For any selected FSM object out of a detector hierarchy, a main module or window supplies the operator with detailed information, while a secondary module or window on the same screen may depict a 3D representation of the object. The contents of the individual modules remain constrained to the respective window of the module. Navigation history can be accessed through generic web-browser type “back” and “forward” buttons.

The present disclosure is directed towards improving on this situation.

### SUMMARY

An exemplary embodiment of the present disclosure provides a method for simplifying navigation for a first user among process control views on a user terminal display of a process control system. The exemplary method includes presenting, on the user terminal display, a current main process control view in a first main view window together with a number of additional views in a second additional views window, receiving, from the first user, a selection of an additional view in the additional views window to be a main process control view, and setting the selected view as current main process control view. In addition, the exemplary method includes choosing a group of views to be presented as additional views in the second additional views window based on an additional view selection criterion, and repeating the presenting of the current main process control view by presenting the selected view as the current main process control view in the first main view window together with the chosen group of views as additional views in the second additional views window.

An exemplary embodiment of the present disclosure provides a user terminal for simplifying navigation for a first user among process control views in a process control system. The exemplary user terminal includes a display, a user input unit, and a control unit. The control unit is configured to present a current main process control view in a first main view window together with a number of additional views in a second additional views window, receive, from the first user via the user input unit, a selection of an additional view in the additional views window to be a main process control view, set the selected view as current main process control view, choose a group of views to be presented as additional views in the second additional views window based on an additional view selection criterion, and repeat presenting the current main process control view in the first main view window according to the received selection with the chosen group of views as additional views in the second additional views window.

An exemplary embodiment of the present disclosure provides a non-transitory computer-readable recording medium having a computer program recorded thereon that causes a processor of a computer processing device in a process control system to simplify navigation for a first user among process control views on a user terminal display of the process control system. The computer program causes the processor to execute operations including: presenting a current main process control view in a first main view window together with a number of additional views in a second additional views window; receiving, from the first user, a selection of an additional view in the additional views window to be a main process control view; setting the selected view as current main process control view; choosing a group of views to be presented as additional views in the second additional views window based on an additional view selection criterion; and repeating the presenting of the current main process control view in the first main view window according to the received selection with the chosen group of views as additional views in the second additional views window.

### BRIEF DESCRIPTION OF THE DRAWINGS

Additional refinements, advantages and features of the present disclosure are described in more detail below with reference to exemplary embodiments illustrated in the drawings, in which:

FIG. 1 schematically shows a computerized process control system according to an exemplary embodiment of the present disclosure;

FIG. 2 schematically shows a user terminal according to an exemplary embodiment of the present disclosure;

FIG. 3A shows a first process control view in the form of a world view or general overview of the process control system according to an exemplary embodiment of the present disclosure;

FIG. 3B shows a second process control view in the form of a single-line diagram of a substation according to an exemplary embodiment of the present disclosure;

FIG. 3C shows a third process control view in the form of an alarm list according to an exemplary embodiment of the present disclosure;

FIG. 3D shows a fourth process control view in the form of a drawing of an element in a substation according to an exemplary embodiment of the present disclosure;

FIG. 3E shows a fifth process control view in the form of a parallel axis diagram of some measured data for a number of elements in a substation according to an exemplary embodiment of the present disclosure;

FIG. 4 schematically shows two windows on a user terminal display where process control views are presented, according to an exemplary embodiment of the present disclosure;

FIG. 5A shows a first grouping of process control views presented to a first user according to an exemplary embodiment of the present disclosure;

FIG. 5B shows a second grouping of process control views being presented to the first user after a selection of one view in the first grouping, according to an exemplary embodiment of the present disclosure;

FIG. 5C shows a third grouping of process control views being presented to the first user after a selection of one view in the second grouping, according to an exemplary embodiment of the present disclosure;

FIG. 6 schematically shows a flow chart of a number of steps being performed in a method according to an exemplary embodiment of the present disclosure; and

FIG. 7 schematically shows an exemplary non-transitory computer-readable recording medium having recorded thereon a computer program which, when executed, causes a processor of a computer processing device to provide the functionality of the method according to the present disclosure.

### DETAILED DESCRIPTION

Exemplary embodiments of the present disclosure are directed towards simplifying navigation for a user among process control views in a process control system.

An exemplary embodiment of the present disclosure provides a method of navigating among process control views on a user terminal display of a process control system, with distinct process control views comprising distinct information or aspects about a primary system such as an electric power transmisson system. The exemplary method includes presenting a current main process control view in a first main-view window together with a number of additional views in a second additional-views window. The exemplary method also includes receiving, from the first user, a selection of one of the additional views in the additional-views window to be a main process control view. In addition, the exemplary method includes setting the selected view as current main process control view, and choosing a group of views to be presented as additional views in the second additional-views window based on an additional view selection criterion. Furthermore, the exemplary method includes repeating, or updating, the step of presenting a current main process control view in the first main-view window according to the received selection together with the chosen group of views as additional views in the second additional-views window.

An exemplary embodiment of the present disclosure provides a user terminal for simplifying navigation for a first user among process control views in a process control system. The user terminal includes a display, a user input unit, and a control unit. The control unit is configured to present a current main process control view in a first main view window together with a number of additional views in a second additional views window, receive, from the first user, a selection of an additional view in the additional views window to be a main process control view, set the selected view as current main process control view, choose a group of views to be presented as additional views in the second additional views window based on an additional view selection criterion, and repeat presenting current main process control view in the first main view window according to the received selection with the chosen group of views as additional views in the second additional views window.

An exemplary embodiment of the present disclosure provides a non-transitory computer-readable recording medium, such as a non-volatile memory (for example, a ROM, hard disk drive, CD/DVD-ROM, flash memory, optical memory, etc.). The non-transitory computer-readable recording medium has recorded thereon a computer program that, when executed, causes a processor of a computer processing device to execute a method of simplifying navigation for a first user among process control views on a user terminal display of a process control system. For instance, the program can cause the processor to execute operations which include presenting a current main process control view in a first main view window together with a number of additional views in a second additional views window, receiving, from the first user, a selection of an additional view in the additional views window to be a main process control view, setting the selected view as current main process control view, choosing a group of views to be presented as additional views in the second additional views window based on an additional view selection criterion, and repeating presenting current main process control view according to the received selection in the first main view window with the chosen group of views as additional views in the second additional views window.

Exemplary embodiments of the present disclosure simplify the navigation for a user of a process control system among a number of process control views, which allows the user to concentrate on more urgent matters. Since the options are visually presented, the right selection is easier to make. The present disclosure can furthermore be implemented at very small additional costs. It can be implemented using additional computer program code, such as a computer program tangibly recorded on a non-transitory computer-readable recording medium.

In the following, exemplary embodiments of the present disclosure illustrate the above described functionality.

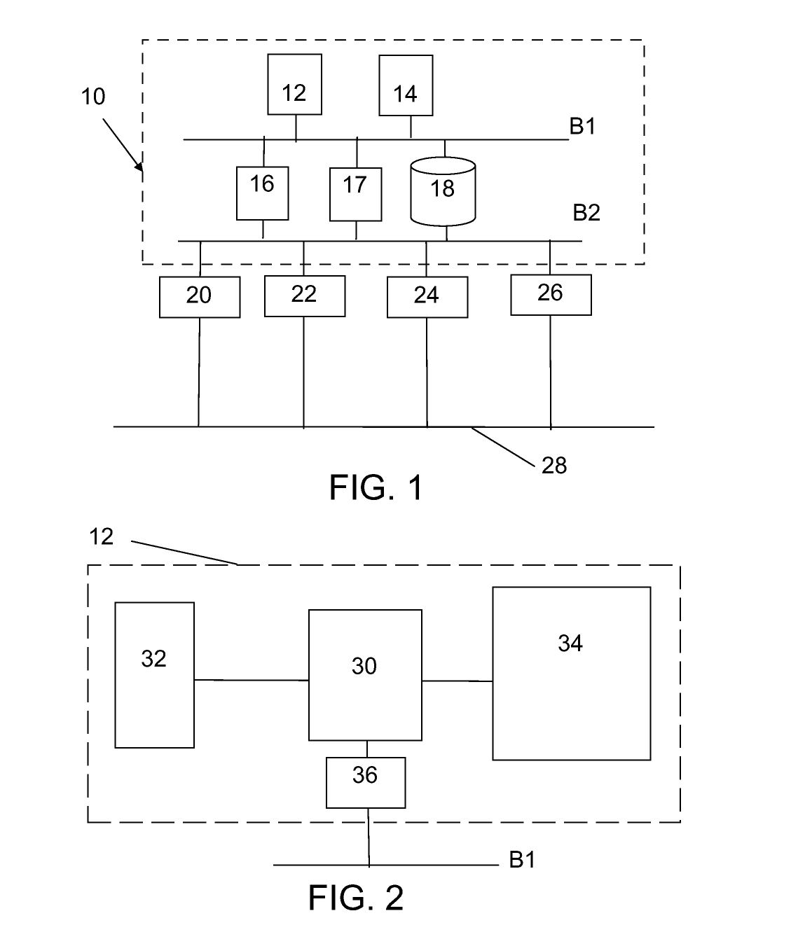

FIG. 1 schematically shows a computerized process control system 10. The process control system 10 may, for example, be an object based computerized system for controlling a technical process or perhaps part of a technical process. Such technical processes may include, for example, electrical power generation, transmission and/or distribution processes, water purification and/or distribution processes, oil and/or gas production and distribution processes, petrochemical, chemical, pharmaceutical and food processing processes, as well as pulp and paper production processes. These are just some examples of technical processes where the process control system 10 can be applied. Countless other technical processes exist. The technical process may be monitored and controlled by a user or user through a user terminal, which communicates with one or more servers handling monitoring and control of the process. An exemplary field where the present disclosure may be applied is a power transmission system.

In FIG. 1, the process control system 10 includes a number of operator and engineering terminals 12 and 14 connected to a first bus B1. Operator and engineering terminals are two different types of user terminals. There is also a second bus B2, and between the first and second busses there are connected a first server 16 providing control of the process, a second server 17 providing monitoring of the process and a database 18 where data relating to control and possibly monitoring of the process is stored. Such data is here also called process control data. To the second bus, there are furthermore connected process interface units for providing control and measurements in the system 10. The first server 16 is therefore a part of a control system, while the second server 17 is a part of a monitoring system. In FIG. 1, there are provided four such process interface units 20, 22, 24 and 26 connected to a power line 28. It should here be realized that some of these may only be provided for control, some only for measurements and some for both control and measurements. Such process interface units are thus involved in controlling the electrical power transmission process or measuring properties of the controlled process as well as properties or status of control and measurement units. Process interface units can include elements directed towards measuring such as current, voltage and power measurement units like current transformers and voltage transformers, as well as elements directed towards control operations like circuit breakers, relays, power semiconductor switches and tap changers. A process interface unit can also be a higher level element like a generator. A process control device may therefore be an entity like a substation, while a process control element is an entity in such a device, such as a transformer. These are just a few of several different possible types of elements that can be provided in process interface units.

The first server 16 here receives measurements of the process via the process interface units and controls the process via the process interface units based on these measurements. It also stores historical process control data in the data base 18. The second server 17 receives measurements via the process interface units as well as status data concerning the operation of process interface units and can generate alarm and event data that may be presented via the user terminals 12 and 14. It can also shut down the process. Also alarm and event data may be stored in the database 18.

In the example of FIG. 1, a so-called Network Manager system runs on the process control system 10, which belongs to the group of SCADA (Supervisory Control And Data Acquisition) systems. The Network Manager system is particularly intended for the supervision and control of power transmission systems or gas systems.

A user terminal 12 and 14 in the process control system 10 provide each a user interface to the Network Manager system. In the following, the details of such a user terminal are explained based on the example of user terminal 12, shown in FIG. 2. The user terminal 12 includes a user input unit 32, a display 34, a control unit 30 and an interface 36 for communicating with the system 10 via the first bus B1. As mentioned above, the user terminal provides a graphical user interface for an operator or user of the process control system 10. The control unit 30 may be a processor with an associated program memory including program code for performing the functionality of the present disclosure, which will be described later on. The user input unit 32 is a unit through which a user of the user terminal 12 may enter data. As such it may be a keyboard, a keypad or a pointing device like a mouse. A combination of these may also be used. It may also be combined with the display 34 in order to form a touch screen. The user terminal 12 may also include other user interfaces such as a speaker or a microphone in order to present and receive data to and from one or more users of the user terminal in other ways than through the display and keyboard. A user terminal in a process control system is only one example of a computer in which the present disclosure may be realized.

Process control data values from the various process interface units can be collected and stored in the history data base 18 by the first server 16 as well as presented in real-time to a user via the user terminal display 34.

On the user terminals 12 and 14 it is possible to show a number of different process control views. A process control view may include an overview of the whole process control system, one or more different views of process control devices such as of a substation, alarm lists, views of process control elements like elements of a substation as well as a process control views of data associated with an element or device, such as statistical data. A number of different types of views may thus exist. This means that a lot of different process control views may exist, for example, views of aspects of the process control system or the technical process.

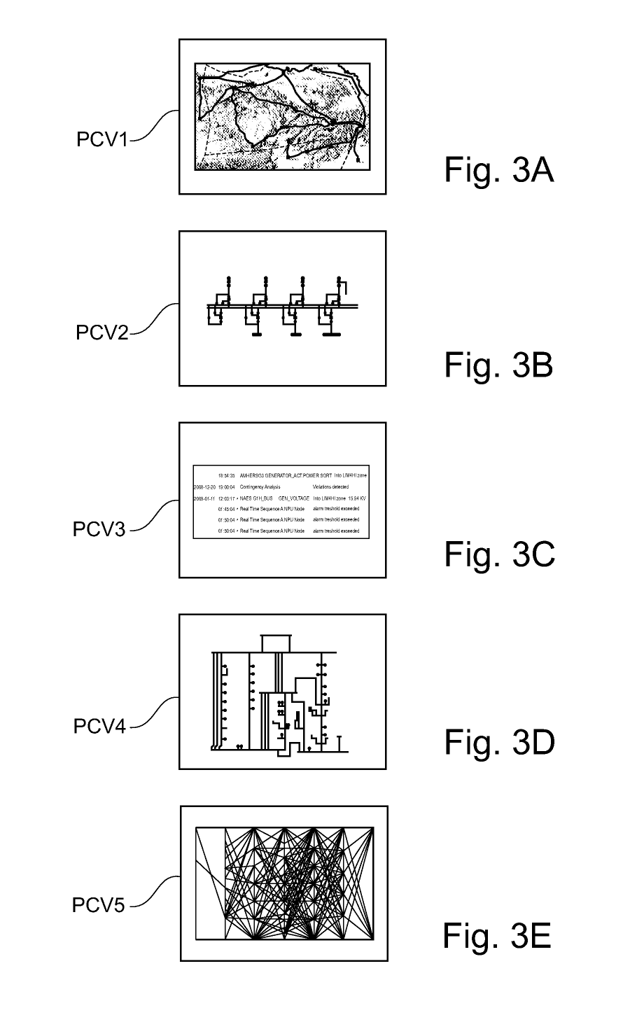

FIG. 3A here shows a first such process control view PCV1, which is a world view of the whole system. This world view is here provided in the form of a geographical map of the system where a number of process control devices in the form of substations are shown as interconnected by power lines. FIG. 3B shows a second process control view PCV2, which is a single line diagram of a substation in the system appearing in the first process control view PCV1. FIG. 3C shows a third process control view PCV3, which is an alarm list on which alarms associated with a process control device, here the substation in the second process control view PCV2, are shown. FIG. 3D shows a fourth process control view PCV4 in the form of a process control element in the substation of the second process control view PCV2. FIG. 3E shows a fifth process control view PCV5 depicting statistical data of process control elements of a process control device, here the process control device depicted in the second process control view PCV2. The data is here shown in relation to time in a parallel axis graph.

It should here be realized that these are just some examples of views that may exist in the system. These views are here used for describing the principles of the present disclosure. The present disclosure is in no way limited to these specific views or these specific types of views, but countless other process control views may exist.

According to an exemplary embodiment of the present disclosure, there are provided a number of process control view windows in which the process control views are displayed simultaneously on one or more of the displays of the process control system.

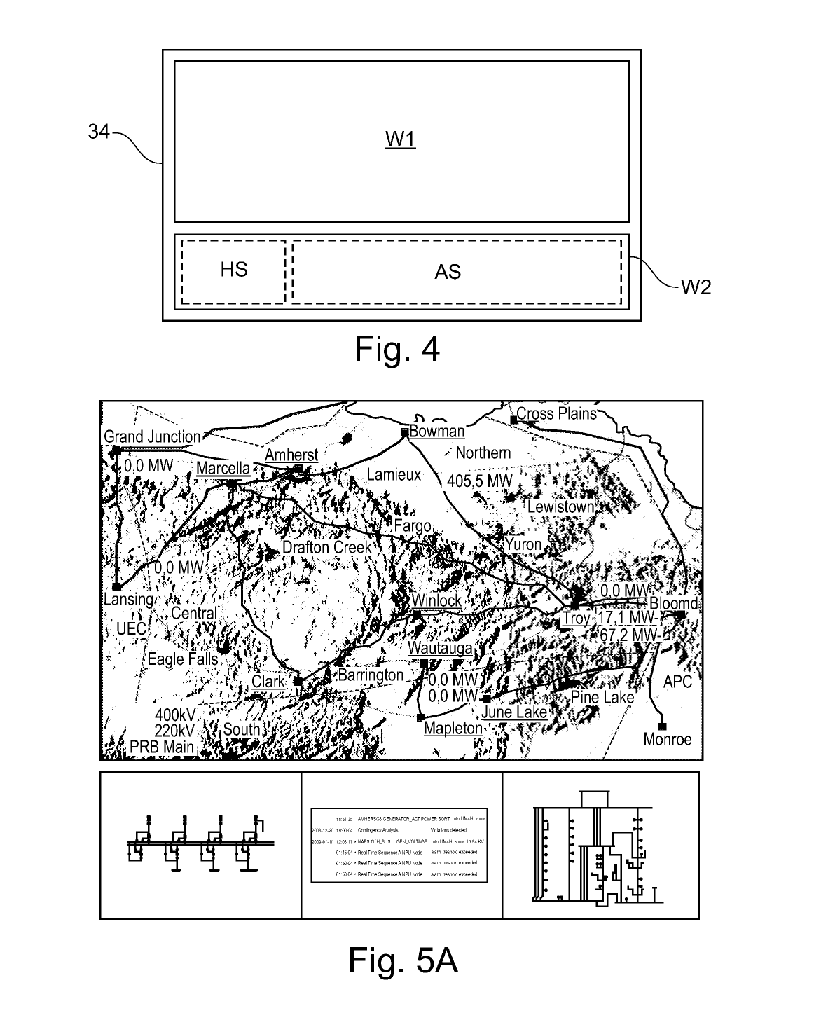

FIG. 4 schematically shows two such exemplifying windows on the display 34 of the user terminal. There is here a first main view window W1 and a second additional views window W2. The first main view window W1 occupies more than half of the display and in this example approximately two thirds of the display, while the second additional views window W2 in this example occupies approximately one third of the display. The second additional views window W2 is furthermore divided into a history section HS and an alternatives section AS. Here the alternatives section AS occupies most of the second additional views window W2 and in this example approximately two thirds of the window, while the history section HS occupies about one third of the second additional views window W2. In the second additional views window W2 it is then possible to display a number of views, while only one view is displayed in the first main view window. The above described sizes of windows and sections are mere examples and should not be taken as limiting the present disclosure. However, the first main view window W1 or rather the view displayed in it, is larger than all the additional views being displayed simultaneously in the second additional views window W2. It may be larger than all the additional views combined. The additional views can alternatively be thumbnail views. It should also be realized that the history section HS need not always be present in the additional views window W2, but only from time to time. In fact, according to an exemplary embodiment of the present disclosure, a history section may not be used at all.

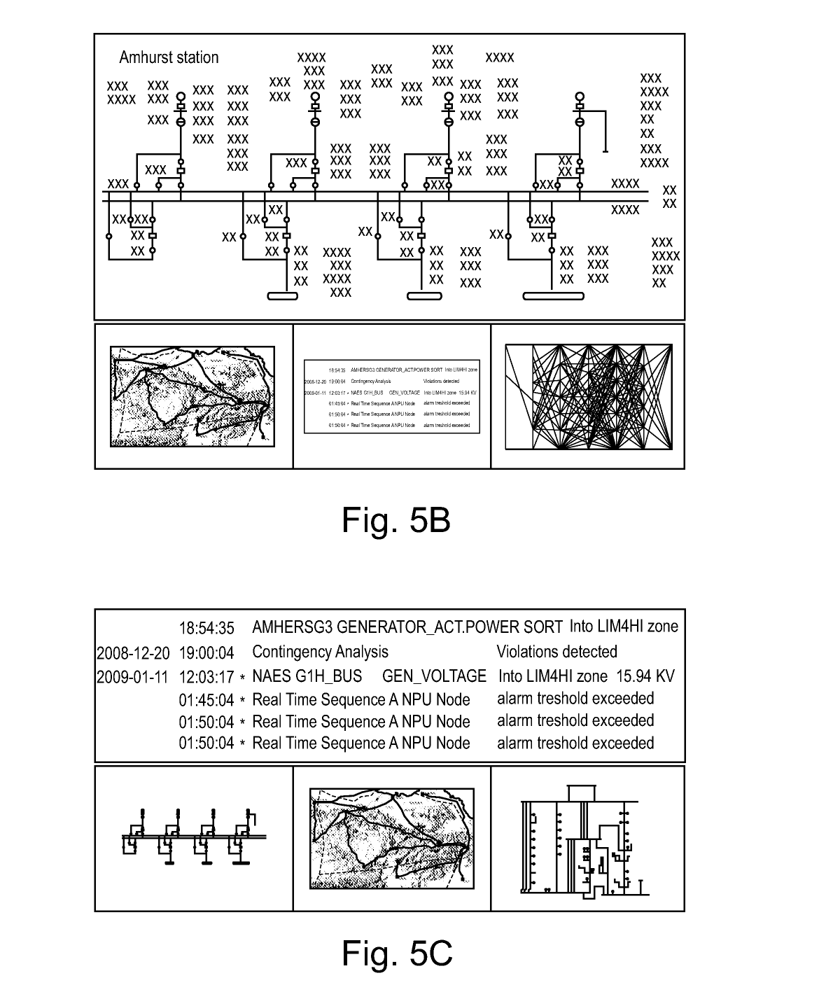

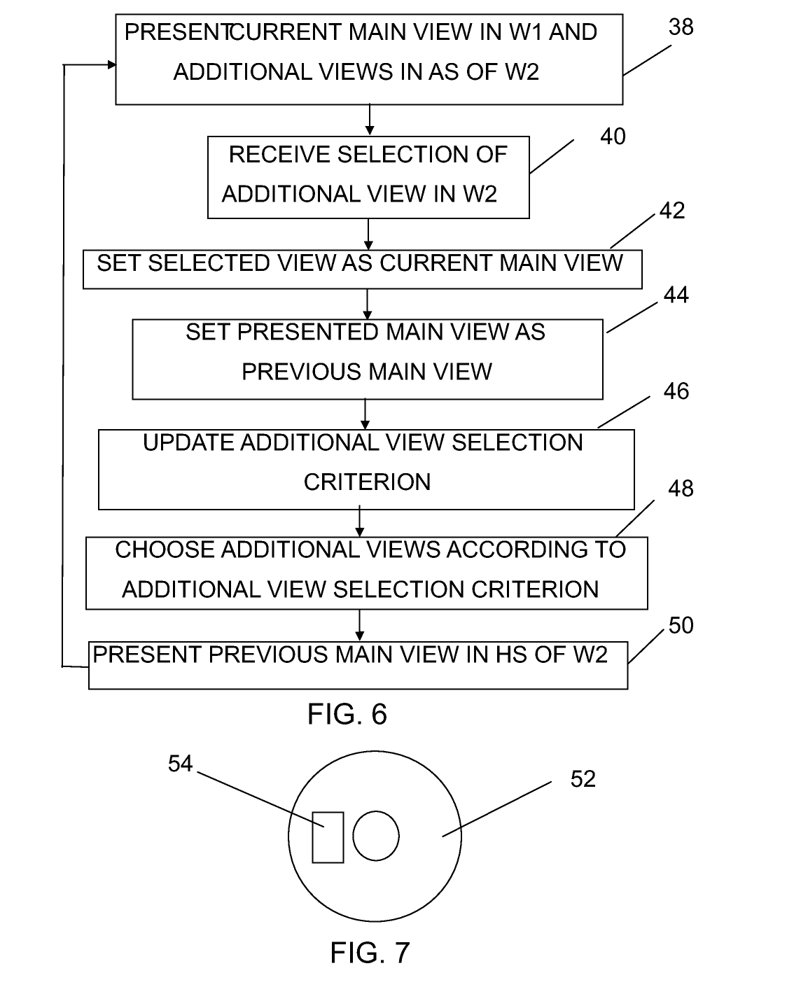

An exemplary embodiment of the present disclosure will be described with reference to FIG. 6, which shows a flow chart of a number of method steps being performed in a method according to the present disclosure, and to FIGS. 5A-C, which show a number of groupings of process control views presented in the first and second windows.

In the context of the exemplified electric power transmission process, a user may be faced with an alarm being displayed in relation to a substation in a world map view, like the first process control view PCV1. This could be done through a symbol representing a substation blinking. The user may then need to open another view, such as a single line diagram view of the substation, like one in the second process control view PCV2, in order to analyze the status of the substation, from there navigate to an alarm and event list view, like the third process control view PCV3 and acknowledge the alarm, then navigate back to the substation view an run an application which results are again displayed in a separate view/picture. A user may therefore need to open several such windows or scenes.

This navigation is traditionally performed in a menu system, where the views are linked to each other in a hierarchical structure. The navigation can be tedious, time consuming and even at times complicated. Another problem with view navigation is that the act of navigating will take away the focus of the user from what is essential, namely viewing the technical process and concentrating and acting on events in the technical process, and instead focus on the activity of locating the information that is needed for being involved in the control of the process. This may in the worst case cause the user to make bad decisions.

The present disclosure is provided for improving on this situation.

As the method according to an exemplary embodiment of the present disclosure is started, one view is a current main view and in this case it is the first process control view PCV1, which is such a main view, which a user is observing on the display 34 of the user terminal 12. This means that the whole of the first main view window W1 is occupied by this first process control view PCV1. The alternatives section AS at this stage occupies the whole of the second alternatives window W2. In the alternatives section AS there are provided the second, third and fourth process control views PCV2, PCV3 and PCV4. This situation is shown in FIG. 5A, which depicts a first grouping of views in the two windows. At this point there is no history section, which means that the second additional views window W2 is completely filled by the alternatives section. The reason for this is that the user, here also denoted a first user, has as yet not made any view selections. The second, third and fourth process control views are here alternative views, which the user may select for replacing the current main view. The views chosen for being presented in the alternatives section may here be pre-determined for instance according to user preferences or based on statistical data either in relation to the first user and/or in relation also to other users. The views may have been chosen according to an additional view selection criterion, to be described later on.

It can here be mentioned that the first user may be able to select also other views to be main process control views through navigating through a traditional menu system. This may be possible in case the alternative views in the second window W2 are not views desirable for the first user.

There are a number of views that are possible to provide as alternatives in the second window W2, like for instance all views available in the system. This means that the views presented as alternatives views in the alternatives section AS of the second additional views window W2 have been selected by the control unit 30 of the work station 12 according to an additional view selection criterion. This criterion may have been set by the user, either before hand or when being logged on, for example, on-line. The criterion may also consider system activities. System activities can be user activities by the first user, a group of users or all users. System activities may instead or additionally include alarms and events. This means that the selection criterion may consider the operational status of the system. The view selection criterion may thus be dynamically updated during a session or during the control of the technical process. In accordance with an exemplary embodiment of the present disclosure, the criterion uses a probability value assigned to an alternative view in relation to which view is the current main view, which probability value reflects the probability that the alternative view in question is selected as a next main view from the current main view. The current main view is thus presented in the first main view window W1 and additional views that may be selected by the first user are at the same time presented in the alternatives section AS of the second additional views window W2, step 38.

The first user may now decide to select to change main view, for instance because of an alarm being notified in relation to one of the substations presented in the overview of the system in the first main view window W1. The first user therefore selects one of the views in the second alternatives window W2. This may be done through clicking on one of the views presented in this latter window. Through this clicking, the control unit 30 of the work station 12 receives a selection of an additional view in the second alternatives window W2 to be a new main process control view, step 40, which selection is thus a selection of change of main view.

When the control unit 30 receives this selection, it first sets the newly selected main view to be a current main view, step 42, and thereafter sets the presented main view, in this example the first process control view PCV1, to be a previous main view, step 44. When this has been done, the control unit 30 updates the additional view selection criterion, step 46. This update may also be based on system activities like user activities and/or alarms and events. This update may also consider which view that was a current main view as the selection took place as well as which view that was selected to replace it as a main view. For the example of probability values, the control unit 30 may update the probability values of all the views based on the selection. Based on this data the control unit 30 updates the probability setting for the different views, for example, it updates the additional view selection criterion in relation to the former or previous main view. The control unit thus updates the part of the additional view selection criterion that is concerned with or based on the previous main view.

At this stage, the control unit may furthermore introduce the history section HS of the second alternatives window W2. This means that the number of views available for the alternatives section AS is reduced compared with the case when the history section did not exist.

After the received selection, the control unit 30 chooses a group of views to be presented as additional views according to the additional view selection criterion and in relation to the current main view, step 48. This may involve choosing the views having the highest probability values, for example, the views being the most probable ones to be selected by the first user to follow as new main views after the current main view. The control unit 30 therefore applies a part of the selection criterion that concerns the current main view. When choosing views, the control unit 30 may also consider other factors, such as how much of the second additional views window W2 is to be occupied by the alternatives section AS as well as how much of this alternatives section an additional view may occupy, for example, how much of the alternative section AS is available for different views. The control unit 30 then presents the previous main view in the history section HS of the second additional views window W2, step 50, and at the same time the current main view in the first main view window W1 and the chosen additional views in the alternatives section AS of the second additional views window W2, step 38.

As an example, the first user here selected the second process control view PCV2, which is a single line diagram of a substation shown in the first process control view PCV1. This may have been done by the first user because an alarm was being indicated to have occurred in this substation on the overview of the system presented in the first process control view PCV1.

This means that the second process control view PCV2 is made into the current main view that is presented in the main window W1, while the first process control view PCV1 is a previous current view that is being presented in the history section HS of the additional views window W2. Additional views are then also chosen according to the selection criterion, which additional view in this example are the third and the fifth process control views PCV3 and PCV5, where the third process control view PCV3 is an alarm list and the fifth process control view PCV5 is a view of measured data over time, for instance of the elements of the substation in the second process control view.

These views are then presented on the user terminal display, which presentation is shown in FIG. 5B depicting a second grouping of views. The new user selected main view PCV2 is thus presented in the first main view window W1, while the previous main view is presented in the history section HS of the second alternatives window W2 and the alternative views chosen by the control unit 30 according to the selection criterion are presented in the alternatives section AS of the second additional views window W2. The first user can then select one of the views in the second additional views window W2. The first user can here select any of the views in this window W2, for example, both in the history section HS and in the alternatives section AS. The selection is then received by the control unit 30, step 42, and causes the control unit 30 to change current and previous main views, step 42 and 44, update the additional view selection criterion, step 46, choose new additional views, step 48, and present the previous main view in the history section, step 50, together with the additional views in the alternatives section AS of the additional views window W2 and the new current main view in the first main view window W1, step 38.

As an example the user may have selected the third process control view PCV3 for viewing an alarm list in order to acknowledge an alarm, which causes the former main view, the second process control view PCV2, to be presented in the history section HS. The new additional views in the alternatives section AS may here be the first process control view PCV1 of the overview of the system and the fourth process control view PCV4, a view depicting an element in the substation, for instance an element in relation to which alarm was generated. This situation is schematically shown in FIG. 5C, which depicts a third grouping of views.

In this way, it is possible to continue to change views that can be selected based on selection criterion.

As mentioned above, the selection criterion can be set according to probability values assigned to the various views. According to an exemplary embodiment of the present disclosure, these values may be set according to the selection pattern of the first user, for example, set individually for users being logged onto the process control system. This may be done in the following way. For a specific process control view being a current main process control view, for instance the first process control view PCV1, all other views, for example, all alternative views, are assigned a probability value p according to p=x/y, where x represents the number of times a particular alternative process control view is chosen when the specific process control view is a main process control view, and y reflects the number of times this specific process control view is chosen as a main view. Initially, both x and y may be set to one. As a particular process control view is selected to replace the specific main view, the value x of this particular view is incremented, while the values x of the other alternative process control views remain unchanged. At the same time, the value y is incremented for all alternative process control views. This means that in the example of FIGS. 5A and 5B, the value x of the second process control view PCV2 to be selected when the first process control view PCV1 is the main process control view is incremented by one, while all other views, in the present example the third, fourth and fifth process control views PCV3, PCV4 and PCV5, retain their old value of x. The value of y is however incremented for all alternative views, in the present example, for the second, third, fourth and fifth views PCV2, PCV3, PCV4 and PCV5. In this way, the probabilities are changed according to the selections made by the first user.

The influences of selections on the change of the criterion can remain over several user sessions or only be valid for one session, a current session. Here, it is possible that there are limitations on which views that can be selected from a main view. It may, for example, only be possible to select views of elements of a device, when a view of this device is depicted in the main view. Elements of other devices may then not be possible to select. It may likewise be possible to select a view depicting a process control device from a main view depicting an element of this device but not views of other process control devices. It is also possible to set probabilities based on the selections made by a group or even all users of the system. It is thus possible to let statistics influence the updating of the criterion. This statistical influence may not not restricted to any particular user session.

It is also possible to omit views from the alternatives section if they are already present in the history section. This means that a view having a high enough probability to be chosen in the group of alternative views will not be chosen since it is already present in the history section. The selection criterion can also be set by the first user, either pre-set before logging onto the system or on-line as the user is logged on. The user may thus customize the presentation of alternative views to his or her own liking. This can be made for each view in the system or just some views, such as views associated with a certain process control device, like a certain substation, for example. The selection criterion can also be set according to use case scenarios, for example, according to views that may be of interest in various system states. These scenarios can be possible to configure by the users.

In the example given above, the history section included only one view. It should be realized that it is possible that history section can include more than one view. The presenting of views in the history section may also be limited. This limitation can be a limitation of numbers, for example, restricting the presentation to the three most recent main views. There may instead or additionally be a time limitation. Views may be removed from the history section based on how long ago they were main views. In this way, it is possible to have a history section of varying size and the size of the alternatives section may be adaptively changed based on the size of the history section. The size of the history section can also be set by the user and also be completely omitted. With the history section it is also possible to step backwards through historical main view selections. If a view in the history section is selected, then the history section may be changed to look the same as when the main view in question previously was main view. In this way, it is possible to replay previous user selections.

As mentioned above, it is possible to consider alarms and events when selecting additional views. Alarms and event may here also influence the updating of the criterion. The updating may involve making the criterion only consider alarm and event data or a combination of alarm and event data and user selections. The generation of an alarm or an event may, for example, change the additional view selection criterion so that only views having a relation to the alarm are presented in the alternatives section. It is, for example, possible that the criterion is changed, perhaps temporarily, until the alarm has been acknowledged or the cause of the alarm removed, so that views including a process control device for which the alarm is generated or views including process control elements for which the alarm was generated receive priority. Other views that may receive priority are views of data of these elements and this device and views including data about the alarm or event itself. This may be handled through the control unit of the user terminal receiving a notification of the alarm from the second server and adjusting, perhaps temporarily, the probability values, for example, raising the probability values of the above mentioned type of views related to the alarm. This will ensure that these views will be provided as alternatives in the alternatives section. After the alarm or event has been handled by the user, the previous probability values existing before the alarm or event may be retrieved without having the raised probabilities affect the criterion. As an alternative, it is possible that the selections during the alarm phase are treated as all other selections in the updating of the criterion.

The user terminal may, as was previously described, be provided in the form of one or more processors together with a non-transitory computer-readable recording medium or media having recorded thereon a computer program that causes the one or more processors to perform the features of the present disclosure. The computer program may also be provided on one or more data carriers and then recorded on the non-transitory computer-readable recording medium or media for execution by the one or more processors to perform the functionality of the present disclosure when the computer program code is loaded in a user terminal.

An exemplary embodiment of the present disclosure therefore also provides a non-transitory computer-readable recording medium (e.g., a non-volatile memory) having recorded thereon a computer program that causes one or more processors of a computer processing device, for example, a user terminal and/or a computer of the process control system, to carry out the method according to the present disclosure. Such a non-transitory computer-readable recording medium is illustrated by example as a CD ROM disk 52 which has recorded thereon a computer program 54, as schematically shown in FIG. 7.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for simplifying navigation for a first user among process control views on a user terminal display of a process control system, the method comprising the steps of:
presenting, on the user terminal display, a current main process control view in a first main view window together with a number of additional views in a second additional views window;
receiving, from the first user, a selection of an additional view in the additional views window to be a main process control view;
setting the selected view as current main process control view;
choosing a group of views to be presented as additional views in the second additional views window based on an additional view selection criterion; and
repeating the presenting of the current main process control view by presenting the selected view as the current main process control view in the first main view window together with the chosen group of views as additional views in the second additional views window.

2. The method according to claim 1, wherein the additional view selection criterion considers system activities.

3. The method according to claim 1, wherein the additional views window includes a history section, and
wherein the method comprises:
setting after receiving a selection of an additional view, the presented main view as a previous main view; and
presenting the previous main view in the history section of the second additional views window.

4. The method according to claim 3, comprising:
limiting the number of views presented in the history section according to at least one of time and number.

5. The method according to claim 1, wherein the additional views window includes an alternatives section, and
wherein the presenting of the current main process control view includes presenting the chosen group of views in the alternatives section.

6. The method according to claim 1, comprising:
updating the additional view selection criterion based on system activities.

7. The method according to claim 6, wherein the system activities include selections of main process control views by at least one user.

8. The method according to claim 7, wherein the selections are selections from more than one user.

9. The method according to claim 7, wherein the selections are selections only from the first user.

10. The method according to claim 9, wherein the updating is valid only for a current session of the first user.

11. The method according to claim 6, wherein each view is provided with a number of probability values each reflecting a probability of being selected as the main process control view when a specific other process control view is a main process control view,
wherein the choosing according to the additional view selection criterion includes choosing the additional views that have the highest probability values in relation to the current main view, and
wherein the updating of the additional view selection criterion includes updating the probability values based on the selection.

12. The method according to claim 6, wherein the system activities include at least one of alarms and events in the process control system.

13. The method according to claim 12, wherein one alarm or event is related to a process control device or a process control element in the process control device and only views with information concerning the alarm or event itself, the device and/or the process control element are included in the group of views.

14. A user terminal for simplifying navigation for a first user among process control views in a process control system, the user terminal comprising:
a display;
a user input unit; and
a control unit, wherein the control unit is configured to:
present a current main process control view in a first main view window together with a number of additional views in a second additional views window;
receive, from the first user via the user input unit, a selection of an additional view in the additional views window to be a main process control view;
set the selected view as current main process control view;
choose a group of views to be presented as additional views in the second additional views window based on an additional view selection criterion; and
repeat presenting the current main process control view in the first main view window according to the received selection with the chosen group of views as additional views in the second additional views window.

15. A non-transitory computer-readable recording medium having a computer program recorded thereon that causes a processor of a computer processing device in a process control system to simplify navigation for a first user among process control views on a user terminal display of the process control system, the computer program causing the processor to execute operations comprising:
presenting a current main process control view in a first main view window together with a number of additional views in a second additional views window;
receiving, from the first user, a selection of an additional view in the additional views window to be a main process control view;
setting the selected view as current main process control view;
choosing a group of views to be presented as additional views in the second additional views window based on an additional view selection criterion; and
repeating the presenting of the current main process control view in the first main view window according to the received selection with the chosen group of views as additional views in the second additional views window.

16. The method according to claim 2, wherein the additional views window includes a history section, and
wherein the method comprises:
setting after receiving a selection of an additional view, the presented main view as a previous main view; and
presenting the previous main view in the history section of the second additional views window.

17. The method according to claim 16, comprising:
limiting the number of views presented in the history section according to at least one of time and number.

18. The method according to claim 17, wherein the additional views window includes an alternatives section, and
wherein the presenting of the current main process control view includes presenting the chosen group of views in the alternatives section.

19. The method according to claim 18, comprising:
updating the additional view selection criterion based on system activities.

20. The method according to claim 19, wherein each view is provided with a number of probability values each reflecting a probability of being selected as the main process control view when a specific other process control view is a main process control view,
wherein the choosing according to the additional view selection criterion includes choosing the additional views that have the highest probability values in relation to the current main view, and
wherein the updating of the additional view selection criterion includes updating the probability values based on the selection.

21. The method according to claim 20, wherein the system activities include at least one of alarms and events in the process control system.
